(19) United States
(12) Patent Application Publication
(10) Pub. No.: US 2025/0071634 A1
(43) Pub. Date: Feb. 27, 2025

(54) ENHANCEMENT TO TCI STATE TIMER OPERATION FOR LTM

(71) Applicant: Nokia Technologies Oy, Espoo (FI)

(72) Inventors: Riikka Karoliina DIMNIK, Espoo (FI); Timo KOSKELA, Oulu (FI); Sanjay GOYAL, Murray Hill, NJ (US)

(21) Appl. No.: 18/798,628

(22) Filed: Aug. 8, 2024

Related U.S. Application Data
(60) Provisional application No. 63/533,742, filed on Aug. 21, 2023.

(51) Int. Cl. H04W 36/00; H04L 5/00; H04W 36/32

(52) U.S. Cl. CPC H04W 36/0072; H04L 5/0048; H04W 36/324

(57) ABSTRACT

A method including: connecting, with an apparatus, to a target cell; starting a timer associated with one or more transmission configuration indicator states; determining that the one or more transmission configuration indicator states were active prior to connecting to the target cell; and based upon the timer running, considering the one or more transmission configuration indicator states as being active for at least one of a lower layer mobility or for intra/inter cell beam management within the target cell.

### TECHNICAL FIELD

The example and non-limiting embodiments relate generally to transmission configuration indicator (TCI) states and, more particularly, to supervising of an active TCI state.

BRIEF DESCRIPTION OF PRIOR DEVELOPMENTS

RAN1 has agreed to at least support unified TCI based framework for beam (TCI) indication in Layer1/Layer2 triggered mobility (LTM).

Activation of TCI states before providing a TCI indication, where the TCI indication is selected from one of the activated TCI state, would be beneficial for achieving low handover latency. This is as the UE may start to track the reference signal (SSB/TRS/CSI-RS) associated with the activated TCI states early on to obtain fine Quasi co-location (QCL) parameters (fine time/frequency synchronization) which may be required before start using the activated beam as the indicated beam.

### SUMMARY OF THE INVENTION

The following summary is merely intended to be an example. The summary is not intended to limit the scope of the claims.

In accordance with one aspect, an example method is provided comprising: connecting, with an apparatus, to a target cell; starting a timer associated with one or more transmission configuration indicator states; determining that the one or more transmission configuration indicator states were active prior to connecting to the target cell; and based upon the timer running, considering the one or more transmission configuration indicator states as being active for at least one of a lower layer mobility or for intra/inter cell beam management within the target cell.

In accordance with another aspect, an example method is provided comprising: determining that an apparatus has connected to a target cell; starting a timer associated with one or more transmission configuration indicator states; determining that the one or more transmission configuration indicator states were active prior to connecting to the target cell; and based upon the timer running, considering the one or more transmission configuration indicator states as being active for a lower layer mobility.

In accordance with another aspect, an example method is provided comprising: determining that an apparatus has connected to a target cell; starting a timer associated with one or more transmission configuration indicator states; determining that the one or more transmission configuration indicator states were active prior to connecting to the target cell; and based upon the timer running, considering the one or more transmission configuration indicator states as being active for intra/inter cell beam management within the target cell.

In accordance with another aspect, an example apparatus is provided comprising: at least one processor; and at least one non-transitory memory storing instructions that, when executed with the at least one processor, cause the apparatus to perform: connecting, with the apparatus, to a target cell; starting a timer associated with one or more transmission configuration indicator states; determining that the one or more transmission configuration indicator states were active prior to connecting to the target cell; and based upon the timer running, considering the one or more transmission configuration indicator states as being active for at least one of a lower layer mobility or for intra/inter cell beam management within the target cell.

In accordance with another aspect, an example apparatus is provided comprising: means for connecting, with the apparatus, to a target cell; means for starting a timer associated with one or more transmission configuration indicator states; means for determining that the one or more transmission configuration indicator states were active prior to connecting to the target cell; and means for, based upon the timer running, considering the one or more transmission configuration indicator states as being active for at least one of a lower layer mobility or for intra/inter cell beam management within the target cell.

In accordance with another aspect, an example apparatus is provided with a non-transitory program storage device readable by an apparatus, tangibly embodying a program of instructions executable with the apparatus for performing operations, the operations comprising: connecting, with the apparatus, to a target cell; starting a timer associated with one or more transmission configuration indicator states; determining that the one or more transmission configuration indicator states were active prior to connecting to the target cell; and based upon the timer running, considering the one or more transmission configuration indicator states as being active for at least one of a lower layer mobility or for intra/inter cell beam management within the target cell

In accordance with another aspect, an example method is provided comprising: determining that a user equipment has connected to a target cell; based upon the determining that the user equipment has connected to the target cell, starting a timer with network equipment for a serving cell; while the timer is running, considering with the network equipment for the serving cell that one or more transmission configuration indicator states are active for the user equipment.

In accordance with another aspect, an example method is provided comprising: based upon at least one of: transmitting a cell switch command in a serving cell to a user equipment for switching to a target cell, or receiving an acknowledging from the user equipment of the cell switch command for switching the user equipment to the target cell, starting a timer with network equipment for the serving cell; and while the timer is running, considering with the network equipment for the serving cell, that one or more transmission configuration indicator states for the user equipment are active.

In accordance with another aspect, an example method is provided comprising: based upon at least one of: transmitting a cell switch command in a serving cell to a user equipment for switching to a target cell, or receiving an acknowledging from the user equipment of the cell switch command for switching the user equipment to the target cell, starting a timer with network equipment for the serving cell; and while the timer is running, considering with the network equipment for the serving cell, that one or more transmission configuration indicator states for the user equipment are active.

In accordance with another aspect, an example method is provided comprising: based upon at least one of: transmitting a cell switch command in a serving cell to a user equipment for switching to a target cell, or receiving an acknowledging from the user equipment of the cell switch command for switching the user equipment to the target cell, starting a timer with network equipment for the serving cell; and while the timer is running, considering with the network equipment for the serving cell, that one or more transmission configuration indicator states for the user equipment are active.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2A shows an example of a layer1/layer2 triggered mobility (LTM) procedure;

FIG. 2B shows an example of a layer1/layer2 triggered mobility (LTM) procedure;

FIG. 3A shows an example procedure with enhancements for activation;

FIG. 3B shows an example procedure with enhancements for activation;

FIG. 4A shows an example method;

FIG. 4B shows an example method;

FIG. 4C shows an example method;

FIG. 5 is a diagram illustrating an example method;

FIG. 6 is a diagram illustrating an example method; and

FIG. 7 is a diagram illustrating an example method.

### DETAILED DESCRIPTION

The following abbreviations that may be found in the specification and/or the drawing figures are defined as follows:
3GPP third generation partnership project
5G fifth generation
5GC 5G core network
AMF access and mobility management function
CSI-RS channel state information reference signal
CU central unit
DL downlink
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
HO handover
I/F interface
LTE long term evolution
LTM layer 1/layer2 triggered mobility
MAC medium access control
MME mobility management entity
ng or NG new generation
ng-eNB or NG-eNB new generation eNB
NR new radio
N/W or NW network
PDCCH physical downlink control channel
PDCP packet data convergence protocol
PDSCH physical downlink shared channel
PHY physical layer
QCL quasi co-location
RACH random access channel
RAN radio access network
Rel release
RLC radio link control
RRH remote radio head
RRC radio resource control
RS reference signal
RU radio unit
Rx receiver
SDAP service data adaptation protocol
SGW serving gateway
SMF session management function
SSB synchronization signal block
TA timing advance
TCI transmission configuration indicator
TRS tracking reference signal
TS technical specification
Tx transmitter
UE user equipment (e.g., a wireless, typically mobile device)
UL-SCH uplink shared channel
UPF user plane function
USIM universal subscriber identity module

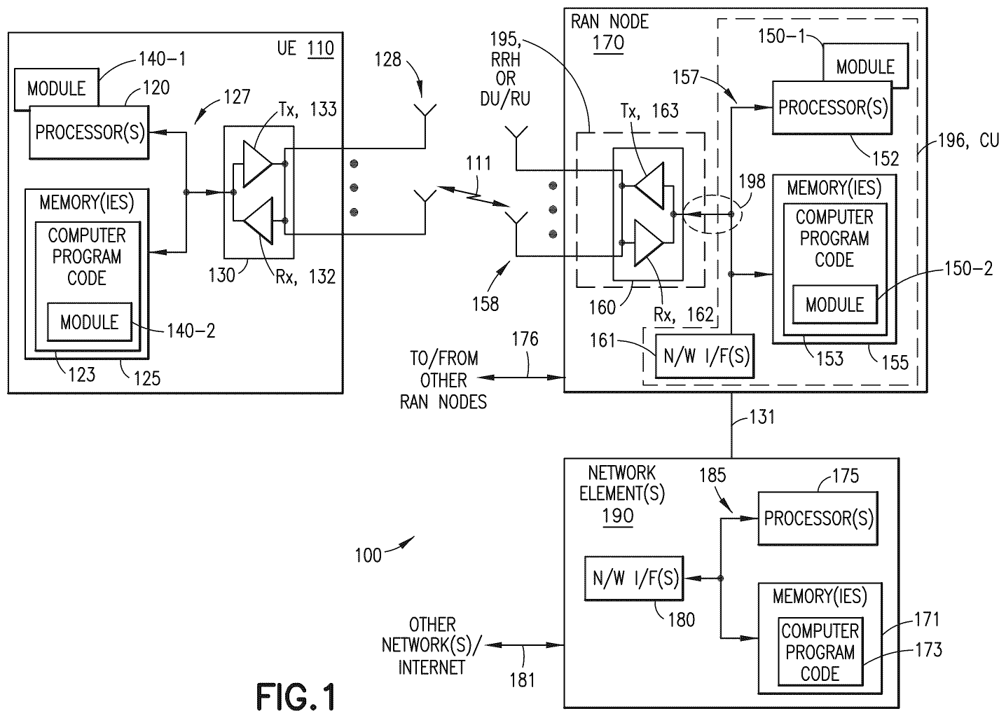

Turning to FIG. 1, this figure shows a block diagram of one possible and non-limiting example in which the examples may be practiced. A user equipment (UE) 110, radio access network (RAN) node 170, and network element(s) 190 are illustrated. Examples of network equipment, network device, or a network entity might be understood to include, at least part of, a transmission reception point or a cell or a gNB or node for example. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

An example embodiment may provide activation information comprising a determination for activation and/or deactivation of TCI states for one or more candidate cells and, more specifically, to providing activation information comprising a determination for activation and/or deactivation of TCI states for one or more candidate cells such that candidate cell may be configured to transmit at least one of SSB, CSI-RS and TRS associated with at least one TCI state when the activation information is received.

Features as described herein may be used to provide common awareness, both at the serving cell and the candidate target cell (each of the candidate cells), on the candidate activated TCI state and the actually activated TCI states.

Features as described herein may be used to provide common awareness, both at the serving cell and each candidate target cell, on the candidate activated TCI state and the actually activated TCI states.

In accordance with an example embodiment of the present disclosure there is provided activation information comprising a determination for activation and/or deactivation of TCI states for one or more candidate cells such that candidate cell may be configured to transmit at least one SSB, CSI-RS, and TRS associated with the TCI states when the activation information is received.

### Rel-18 Lower Layer Mobility

In 3GPP, lower layer mobility is being discussed in Release-18 as a part of the work item called Further NR mobility enhancements [RP-222332]. It has been agreed to use the term Layer1/Layer2 triggered mobility (LTM) for lower layer mobility. In the work items description [RP-222332], objective #1 addressing LTM is as described follows:
To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signaling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet
   Timing Advance (TA) management [RAN1, RAN2]
   CU-DU interface signaling to support L1/L2 mobility, if needed [RAN3]
Note 2: FR2 specific enhancements are not precluded, if any.
Note 3: The procedure of L1/L2 based inter-cell mobility are applicable to the following scenarios:
   Standalone, CA and NR-DC case with serving cell change within one CG
   Intra-DU case and intra-CU inter-DU case (applicable for Standalone and CA: no new RAN interfaces are expected)
   Both intra-frequency and inter-frequency
   Both FR1 and FR2
   Source and target cells may be synchronized or non-synchronized

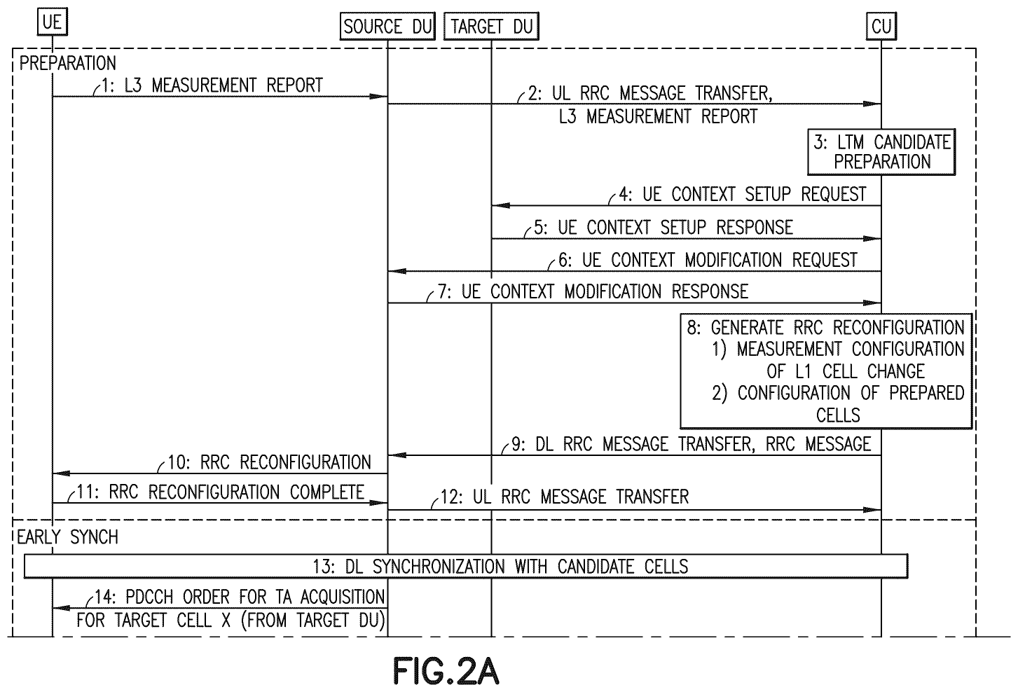

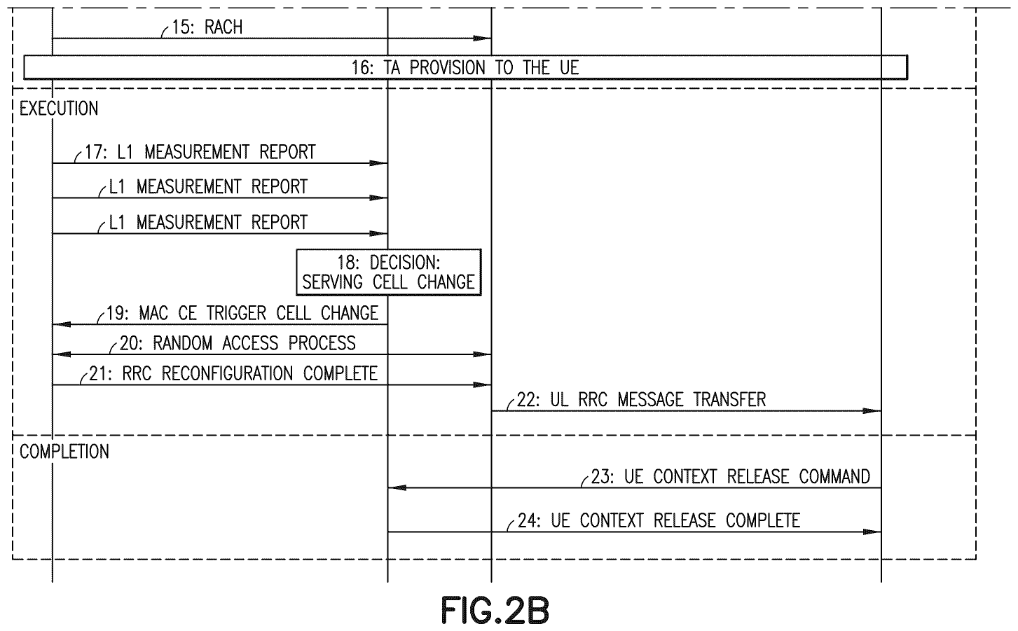

Following the latest agreements, the LTM procedure can be captured in the following MSC [R2-2213292], expanded for disaggregated architecture. According to that, and referring also to FIG. 2A and FIG. 2B:
Steps 1-3: The UE sends a L3 Measurement Report message to the CU via the Source DU. The CU decides to use LTM and initiates LTM candidate cells preparation.
Steps 4-5: The CU sends a UE context setup request to the target DU for the preparation of the target cells
Steps 6-7: The CU sends a UE context modification request to the source DU for the preparation of the target cells in the source DU. Additionally this message may be used for the provision of target cell information to the Source DU.
Steps 8-12: The CU prepares the RRC Configuration and provides it to the UE. The UE stores the configuration of LTM candidate target cell(s) and transmits a RRCReconfigurationComplete message to the CU.
Steps 13: The UE may perform DL synchronization.
Steps 14-16: The Source DU indicates to the UE to perform TA acquisition using RACH to the target DU. The Target DU then provides the TA to the UE (several options exist that are still open-either directly, or via the Source DU).
Step 17: The UE performs L1 measurements on the configured LTM candidate target cell(s), and transmits lower-layer measurement reports to the source DU.
Step 18-19: The source DU decides to execute LTM cell switch to a target cell, and transmits a MAC CE triggering LTM cell switch.
Step 20: The UE switches to the configuration of the LTM candidate target cell and accesses the target cell. If needed (if Timing Advance is not available) it performs Random Access.
Steps 21-22: The UE indicates successful completion of the LTM cell switch towards target cell using an RRC Reconfiguration complete.
Steps 23-24: UE context is released if the CU decides accordingly.

The MAC-CE command in step 19 is also called cell switch command. It has been agreed in RAN1 that this command will at least contain the beam indication of the target cell which the UE may use to communicate with the target cell after the cell switch. Also, it has been agreed to use Release-17 unified TCI based framework to provide a beam indication of the target cell. A beam indication may simply refer to a TCI state of the relevant cell.

The following agreements are a sub-set of agreements made in Rel-18 RAN1 meetings on LTM about the beam indication:
Beam indication for Rel-18 LTM is designed based on Rel-17 unified TCI framework, if both serving cell and candidate cell support Rel-17 unified TCI framework
For beam indication timing for Rel-18 LTM, Support Scenario 2: Beam indication together with cell switch command,
Beam indication for the target cell(s) is conveyed in the MAC CE used for LTM triggering for scenario 2
At least for Rel-17 unified TCI framework based beam indication included in cell switch command (i.e. scenario 2), beam indication applies to signals/channels that follow or are configured to follow Rel-17 unified TCI at the target cell(s).
For the Rel-17 unified TCI based beam indication in Rel-18 LTM, at least TCI state activation of a candidate cell is received before the reception of beam indication of the candidate cell.
A UE can be indicated and activated a single joint TCI state or a pair of UL/DL TCI state in the cell switch command.
Each TCI state included up to 2 qcl-types and each qcl-type source RS in a QCL-Info of the TCI state is provided at least based on the RS configuration for LTM.
For TCI state activation for candidate cell(s) before the cell switch command, MAC CE is used and the details of MAC-CE for TCI state activation for LTM is up to RAN2

### LTM and CU/DU Network Architecture in 3GPP

In 3GPP, LTM refers to layer 1 (L1)/layer 2 (L2) triggered mobility (which is also referred to as L1/L2 inter-cell mobility). LTM represents mobility enhancements that provide, among other things, a decision about a cell change based on at least L1 measurements (e.g., physical layer measurements), and this decision is made, according to the 3GGP, in the medium access control (MAC) (e.g., layer 2) portion of a gNB-DU. In 5G (also referred to as new radio (NR) for example), the base station (e.g., the next generation Node B, gNB) may be a split or distributed base station that includes a gNB central unit (CU) and one or more gNB distributed units (DUs), which may serve one or more cells. For example, a DU may include one or more transmission reception points (TRPs) to serve one or more corresponding cells. The gNB CU may include non-time-critical functionalities (which could be hosted locally or on the cloud). The gNB-DUs include real-time functionalities such as radio link control (RLC), medium access control (MAC), and physical (PHY) layer functions. The F1 interface provides control (F1-C) and user (F1-U) plane connectivity between the CU and DUs. The F1 interface also provides separation between the radio network and transport network layers, while enabling the exchange of UE and non-UE associated information.

### R17, Unified TCI State Framework

Rel-17 unified TCI based framework for beam (TCI) indication in LTM is supported. In unified TCI State framework (or unified TCI) the UE may be provided with a RRC configured list of TCI states (e.g., 64 TCI states) that can be activated (e.g., up to 8 TCI states) using a MAC CE and further indicated (one TCI state) using a DCI. In case of a single TCI activation by the MAC-CE, the one activated is considered as the indicated TCI state. The TCI States can be separately indicated for UL and DL (separate TCI state) or joint TCI i.e. the same TCI is applied for UL and DL.

DCI indication (providing the beam indication) comprises a codepoint value which maps/refers to the TCI State ID activated by the MAC CE (as the MAC-CE may activate up to 8 TCI states).

### Delay Requirement to Use an Activated TCI State

For unified TCI state activation of one or more joint or separate DL/UL unified TCI states, RAN4 has defined the delay requirements in section 8.15 of TS 38.133 for activation of DL TCI state and in section 8.16 for activation of UL TCI state. The requirements are defined for TCI state activation (addition of TCI state on active TCI state list) separately when one (section 8.15.3 and 8.16.3) or more (section 8.15.5 and 8.16.5) TCI states are activated.

TCI state switching delay for addition of one TCI state on the active TCI state list is defined separately for a known and unknown TCI state. For example, for the known TCI state case the delay requirement for DL TCI state is as follows:
If the target TCI state is known, upon receiving PDSCH carrying MAC-CE activation command in slot n, UE shall be able to receive UE-dedicated PDCCH/PDSCH with target TCI state of the serving cell on which TCI state switch occurs at the first slot that is after slot n+T_{HARQ}+3Nₛₗₒₜ^{subframe,μ}+TOₖ*(T_{first-SSB}+T_{SSB-proc})/NR slot length. The UE shall be able to receive UE-dedicated PDCCH/PDSCH with the old TCI state until slot n+T_{HARQ}+3Nₛₗₒₜ^{subframe,μ} where T_{HARQ} (in slot) is the timing between DL data slot transmission and acknowledgement as specified in TS 38.213 [3];
   T_{first-SSB} is time to first SSB transmission after MAC CE command is decoded by the UE; The SSB shall be the QCL-TypeA or QCL-TypeC to target TCI state
   T_{SSB-proc}=2 ms;
   TOₖ=1 if target TCI state is not in the active TCI state list for PDSCH/PDCCH, 0 otherwise.

RAN1 has agreed to at least support unified TCI based framework for beam (TCI) indication in LTM. As noted in U.S. provisional patent application No. 63/459,035 filed Apr. 13, 2023, which is hereby incorporated by reference in its entirety, activation of TCI states before providing the TCI indication (TCI indication is selected from one of the activated TCI states) would be beneficial for achieving low handover latency as the UE may start to track the reference signal (SSB/TRS/CSI-RS) associated with the activated TCI states early on to obtain fine Quasi co-location (QCL) parameters (fine time/frequency synchronization) which may be required before starting to use the activated beam as the indicated beam. As described in U.S. provisional patent application No. 63/459,035, a timer is configured for the UE, wherein the timer is used to supervise validity of the activated TCI States. The validity timer is started when the UE determines that it has received TCI State activation for LTM purposes (i.e. not intra-cell BM). When the timer is running, the UE considers the TCI states as active and may be expected to be prepared for cell switch and/or beam indication to one of the active TCI state (of the target candidate cell). When the timer expires, the UE assumes that the TCI states that are associated with the expired timer to be de-activated. The above may be conditioned whether the UE is configured with a timer or not. If not, the activated TCI states do not expire.

In case if the TCI activation has not been done before the cell switch or a cell change, the UE would need to satisfy a certain minimum delay requirement (in order to obtain fine time/frequency synchronization) before it can start using the indicated beam.

Thus in typical scenarios, the UE will be provided an activation command for a set of TCI States (one or more) that can be indicated by the network; furthermore, in LTM scenario UE may have one or more candidate cells.

The beam indication can be used to indicate an active TCI state. Currently, if the activation command (and later indication) for the TCI state(s) is provided to UE, and only upon the cell switch or cell change also indicated to the target cell, there may be a mismatch of timelines between the target cell and the UE, for example, the UE is ready to receive/transmit but the target DU may still internally processing the beam indication (i.e. arrange transmission schedules and capacity etc.). In other words, the target DU would need to be prepared to accommodate (e.g. in terms of reference signal transmissions, scheduling etc.) the new UE entering the cell on any TCI state that has been configured by the RRC.

Thus, there is a need to have mechanisms to provide common awareness both at the serving cell and the candidate target cell (each of the candidate cells) on the candidate activated TCI state and the actually activated TCI states.

As similarly stated above, there is a need to have mechanisms to provide common awareness both at the serving cell and the candidate target cell (each of the candidate cells) on the candidate activated TCI state and the actually activated TCI states.

In one example embodiment of the present disclosure, when the source cell determines to activate one or more TCI states for one or more candidate cells, the information of the activated TCI states in a message (e.g., activation message) is provided to the associated cell or cells.

Wherein upon receiving the list of one or more activated TCI states by a candidate cell, it may assume that the TCI States are active and one (or more) of the active TCI States may be indicated for the UE. The candidate cell may be configured to transmit at least one the SSB, CSI-RS and TRS (associated with the activated TCI state(s)) when the activation information has been received containing the information of the activated TCI state(s).

The association of the reference signals (e.g. at least one of the SSB, CSI-RS and TRS) with a TCI state may imply/mean that the TCI state includes the associated reference signal(s). Alternatively or additionally, the reference signal included in the TCI state is used as quasi colocation (QCL) source reference signal for another (target) reference signal(s). As an example, if a TCI state is activated and the reference signal (used as a source) associated with the TCI State is transmitted, the target signal may be transmitted. As an example, if a TCI state is activated and a reference signal is associated with the TCI State, the target signal may be transmitted.

The quasi co-location assumption (i.e. there is a QCL source and a QCL target) between source and target signal means that they may share the same properties from (the UE) reception point of view e.g. in terms of Doppler shift, Doppler spread, average delay, delay spread, spatial RX (same RX beam may be used by UE for both signals)

In one example embodiment, when the source cell determines to de-activate one or more TCI states for one or more candidate cells, the information of the de-activated TCI states in a message (e.g., de-activation message) is provided to the associated cell or cells.

Wherein upon receiving the list of de-activated TCI states by a candidate cell, it may assume that the TCI States indicated as de-activated are no longer active. The candidate cell may determine not to transmit at least one the SSB, CSI-RS and TRS (associated with the TCI state(s)) when the TCI state is not activated. Any TCI state not indicated as de-activated, are still active.

In one example embodiment, a target cell may provide list of “candidate TCI states” that can be considered for activation. In one option, the source cell may be required to select one or more of the TCI States for activation from the list provided by the target cell.

In one example embodiment, a timer based management method for the activated TCI states may be configured for the candidate cell(s):
A timer is configured to be maintained at a candidate cell;
The timer is started: when the candidate cell receives activation indication for one or more TCI States:
   same timer may be configured and started at the source cell;
When the timer is running, the candidate cell may assume that the TCI States are active and one (or more) of the active TCI States may be indicated for the UE. The candidate cell may be configured to transmit at least one the SSB, CSI-RS and TRS (associated with the TCI state(s)) while the timer is running:

In a further example, while the timer is running, the candidate cell is expected to be prepared to provide communication on the TCI state resources (e.g., if the beam indication provided to the UE is one of the TCI states of that candidate cell);
When the timer expires: The candidate cell may automatically de-activate the TCI states received from the source cell after the time duration T;

In a further example, the time duration T is communicated to the source DU and the UE. In addition, the UE may also be indicated by the source cell when the activation indication is sent to the candidate cell;
Timer may be specific for a candidate cell or set of candidate cells;
Timer value may be determined by the candidate cell (or the CU of the candidate cell) and the timer value may be indicated to the source cell (and/or other cells) as a part of the LTM configuration.

In one further UE related example embodiment, a timer is configured for the UE, wherein the timer is used to supervise validity of the activated TCI States:
the validity timer is started when the UE determines that it has received TCI State activation for LTM purposes (i.e. not intra-cell BM);
When the timer is running, the UE considers the TCI states as active and may be expected to be prepared for cell switch, cell change, and/or beam indication to one of the active TCI state (of the target candidate cell);
When the timer expires, the UE assumes that the TCI states that are associated with the expired timer to be de-activated;
The above may be conditioned whether the UE is configured with a timer or not. If not, the activated TCI states do not expire.

In one example embodiment of the present disclosure, upon cell switch or cell change command (and the associated beam indication) transmission to the UE, the source DU may provide an indication to the other candidate target DUs to release the activation (i.e. determine that the TCI States are no longer activated for beam indication), thus the receiver target DUs, after receiving the activation, may apply energy saving i.e. determine not to transmit one or more reference signals associated with the TCI State(s) activated for the LTM at least for a UE at the source cell.

In one further example embodiment, the indication to release at least one activation to a candidate target cell/DU may include one or more TCI states (e.g., selected from the activated TCI states of the candidate cell). The candidate target cell/DU may deactivate the indicated TCI states.

In one example option, a candidate target DU to which the indication is sent may be the target DU selected for the cell switch or cell change for the UE.

In another example, a candidate target DU to which the indication is sent may be the target DU not selected for the cell switch or cell change for the UE.

Herein the terms cell switch and cell change may be used interchangeably.

In one example embodiment, upon cell switch command (and the associated beam indication) transmission to the UE, the source DU may provide indication to the other candidate target DUs to NOT release the activation (i.e. determine that the TCI States are still activated for beam indication).

In an example option, this may restart the timer for managing the active state of the TCI states.

In one further example embodiment, the indication to NOT release the activation to a candidate target cell/DU may include one or more TCI states (e.g., selected from the activated TCI states of the candidate cell). The candidate target cell/DU may keep activated the indicated TCI states.

In one example option, a candidate target DU to which the indication is sent may be the target DU selected for the cell switch for the UE.

In another example, a candidate target DU to which the indication is sent may be the target DU not selected for the cell switch for the UE.

In one example embodiment, the beam indication (or the information of a beam indication, e.g., TCI state) to a specific target cell may be communicated to one or more candidate target cells (other candidate target cell not selected for cell switch):
option 1 it could cause a receiver candidate target cell to consider one or more activated TCI states to be deactivated for that UE;
option 2 it could cause a receiver candidate target cell to restart of the timer to maintain the active TCI States still as active. motivation: the UE may be handed over to another cell soon since the UE is most likely at the cell border. This would have implication also to UE since the UE should be ready for another beam indication (i.e. it should not considered the TCI States deactivated for the other cells).

In one example option, the UE may be indicated (e.g., in the cell switch command) about the candidate target cells which may maintain the TCI states as active after the cell switch command.

In one example option, the information of the beam indication may contain the information of the selected target cell (e.g., identity of the target cell).

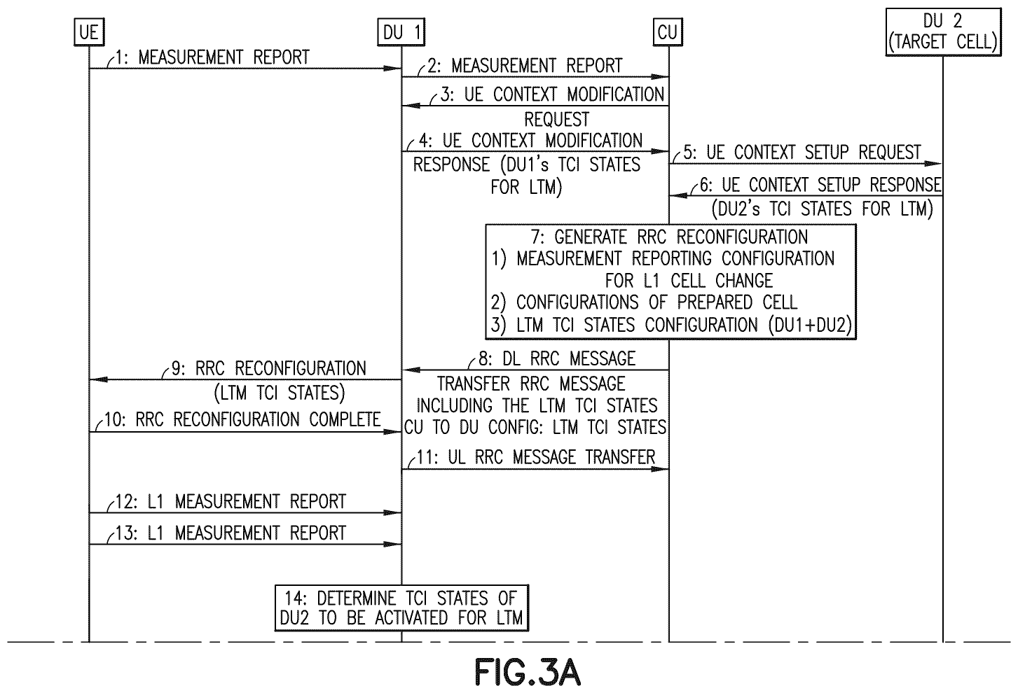

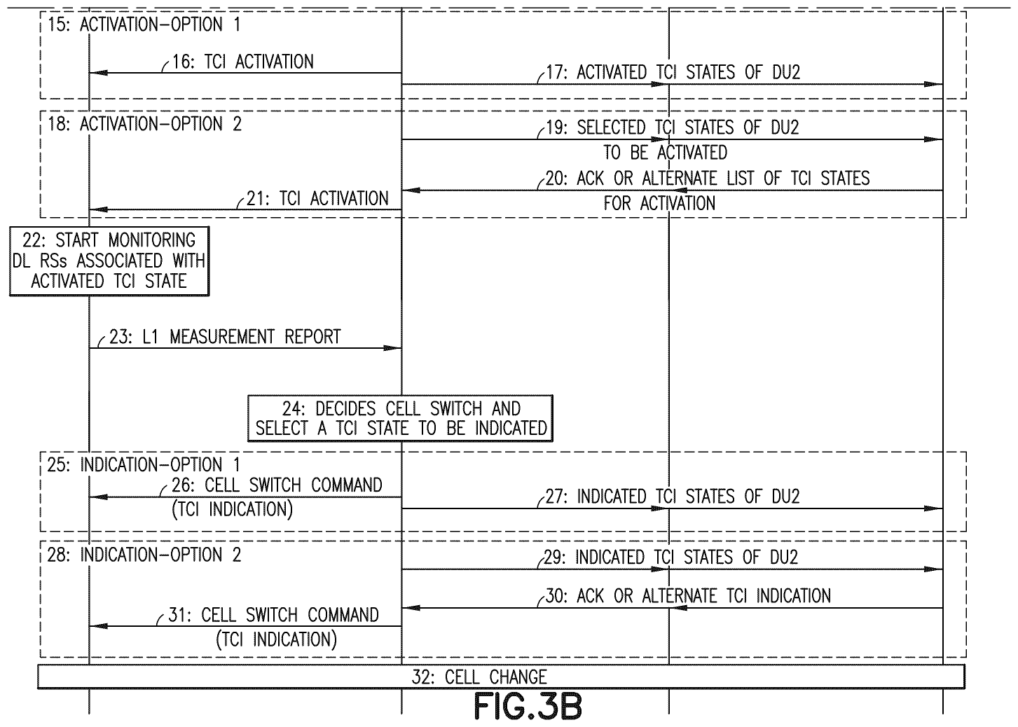

An example of potential signaling may comprise a basic procedure only showing the activation part when the information of the active TCI states is coordinated with the associated candidate cell at the time of TCI activation before the cell switch. These enhancements for activation are shown in FIG. 3A and FIG. 3B.

FIG. 3A and FIG. 3B show a procedure with enhancements for activation. Novel operations of FIG. 3A and FIG. 3B can be see beginning at step 14 of FIG. 2A and FIG. 2B. As shown in step 14 where DU 1 determines TCI states of DU 2 to be activated for LTM. As shown in step 16 of FIG. 3A and FIG. 3B there is during an 15 Activation-Option 1 a TCI activation between the DU 1 and the UE of FIG. 3A and FIG. 3B. As shown in step 17 of FIG. 3A and FIG. 3B there is another operation in accordance with example embodiments of the present disclosure where DU 1 sends towards the CU and DU 2 (target cell) information of the activated states of the DU2. As shown in step 19 of FIG. 3A and FIG. 3B there is during an 18 Activation-Option 2 selected TCI states of DU2 to be activated. As shown in step 20 of FIG. 3A and FIG. 3B there is during the 18 Advance-Option 2 an ACK or alternate list of TCI states for activation sent from the DU 2 to the DU 1. After a step 24 as in FIG. 3A and FIG. 3B where the DU 1 decides cell switch and selects a TCI state to be indicated, there is another step 30 of FIG. 3 where the DU 2 sends to the CU and the DU 1 an ACK or alternate TCI indication. As shown in step 25 of FIG. 3A and FIG. 3B there is an 25 Indication-Option 1. During this Indication-Option 1 as shown in step 26 of FIG. 3A and FIG. 3B there is a cell switch command (TCI indication) from the DU1 to the UE. As shown in step 27 of FIG. 3A and FIG. 3B the DU 1 sends towards the CU and DU 2 (target cell) indicated TCI states of DU 2. Or as shown in step 28 of FIG. 3A and FIG. 3B there is an 28 Indication-Option 2. During this Indication-Option 2 as shown in step 29 of FIG. 3A and FIG. 3B there is sent from the DU 1 towards the CU and DU 2 (target cell) indicated TCI states of DU 2. Then as shown in step 30 of FIG. 3A and FIG. 3B there is sending from the DU 2 towards the CU and DU 1 an ACK or alternative TCI indication. As shown in step 31 of FIG. 3A and FIG. 3B there is sending from the DU 1 towards the UE a cell switch command (TCI indication). Then as shown in step 32 of FIG. 3A and FIG. 3B there is a cell change. At least some of these steps are added to improve operations for TCI state activation or deactivation during for example a cell change.

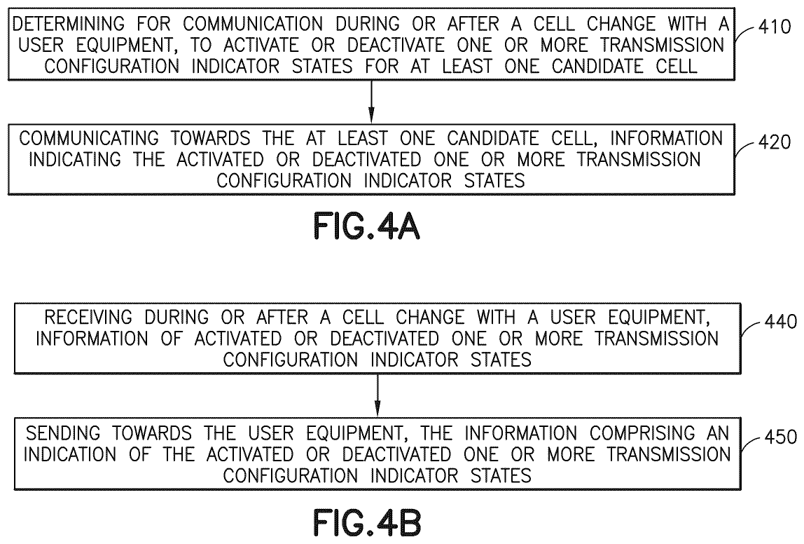

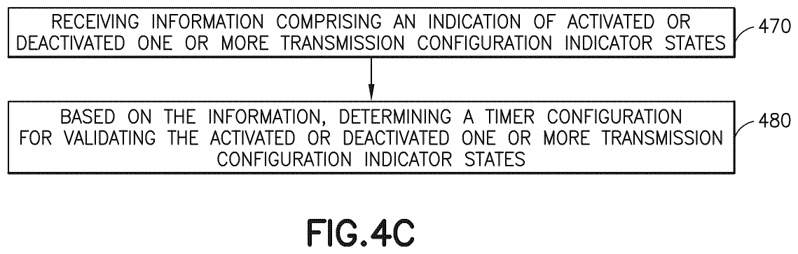

FIG. 4A, FIG. 4B, and FIG. 4C each show an example method.

FIG. 4A illustrates operations which may be performed by a network node. As shown in step 410 of FIG. 4A there is determining for communication during or after a cell change with a user equipment, to activate or deactivate one or more transmission configuration indicator states for at least one candidate cell. As shown in step 420 of FIG. 4A there is communicating towards the at least one candidate cell, information indicating the activated or deactivated one or more transmission configuration indicator states.

In accordance with an example embodiment, the apparatus may be embodied in a network node that is of a source cell of a communication network.

In accordance with an example embodiment, the information may comprise an activation information.

In accordance with an example embodiment, the information may be configured to cause the at least one candidate cell to transmit at least one of a synchronization signal block, a channel state information-reference signal, a tracking reference signal, or other signal.

In accordance with an example embodiment, the information may be configured to cause the at least one candidate cell to transmit at least one of a synchronization signal block, a channel state information-reference signal, a tracking reference signal, or other signal associated with at least one transmission configuration indicator state.

In accordance with an example embodiment, the information may be configured to cause the at least one candidate cell to transmit at least one of a synchronization signal block, a channel state information-reference signal, a tracking reference signal, or other signal associated with the activation information (comprising one or more TCI states).

In accordance with an example embodiment, there may be providing the at least one candidate cell with an activation message for one or more transmission configuration indicator states.

In accordance with an example embodiment, there may be sending a configuration of a timer to the at least one candidate cell.

In accordance with an example embodiment, the timer may be configured when the activation message is provided to a candidate cell.

In accordance with an example embodiment, the timer may be configured to start when the activation message is provided.

In accordance with an example embodiment, the timer may be configured to cause the candidate cell to identify the activated or deactivated one or more transmission configuration indicator states as active when the timer is running, and wherein the activated or deactivated one or more transmission configuration indicator states are activated for the user equipment.

In accordance with an example embodiment, the timer may be configured to cause the at least one candidate cell to transmit at least one of a synchronization signal block, a channel state information-reference signal, a tracking reference signal, or other signal while the timer is running.

In accordance with an example embodiment, the timer may be configured to cause the at least one candidate cell to provide communication to the user equipment on one or more resources associated with the activated or deactivated one or more transmission configuration indicator states while the timer is running.

In accordance with an example embodiment, the at least one candidate cell may be configured to provide communication to the user equipment based on a beam indication provided to the user equipment is the one of activated or deactivated one or more transmission configuration indicator states.

In accordance with an example embodiment, the timer may be configured to cause the at least one candidate cell to, based on expiration of the timer, de-activate the activated one or more transmission configuration indicator states communicated by the source cell after a time duration T.

In accordance with an example embodiment, the communication may configure the at least one candidate cell with the time duration T.

In accordance with an example embodiment, the configuration of the timer to the at least one candidate cell may be communicated as part of a lower layer mobility configuration.

In accordance with an example embodiment, the configuration of the timer communicated as part of the lower layer mobility configuration may comprise at least one of a layer 1 or layer 2 triggered mobility configuration.

In accordance with an example embodiment, the configuration of the timer may be specific for a candidate cell or set of candidate cells of the at least one candidate cell.

In accordance with an example embodiment, there may be based on a cell change command, sending towards the at least one candidate cell an indication to release at least one activation for a beam indication, wherein the release enables the at least one candidate cell to determine not to transmit one or more reference signals associated with the activated or deactivated one or more transmission configuration indicator states activated for the lower layer mobility for a user equipment.

In accordance with an example embodiment, the indication to release the at least one activation sent to the candidate target cell may comprise one or more of the activated transmission configuration indicator states selected from activated transmission configuration indicator states of a candidate cell.

In accordance with an example embodiment, there may be based on a cell switch command sent to the user equipment, sending towards the at least one candidate cell an indication to not release at least one activation for a beam indication.

In accordance with an example embodiment, the indication to release may cause the timer to restart for managing and maintaining the active state of the one or more of the activated transmission configuration indicator states.

In accordance with an example embodiment, the indication to release may comprise one or more activated transmission configuration indicator states selected from activated transmission configuration indicator states of the candidate cell.

In accordance with an example embodiment, there may be sending towards the at least one candidate cell information on a beam indication or an activated transmission configuration indicator state to a specific target cell.

FIG. 4B illustrates operations which may be performed by a network node. As shown in step 440 of FIG. 4B there is receiving during or after a cell change with a user equipment, information of activated or deactivated one or more transmission configuration indicator states. As shown in step 450 of FIG. 4B there is sending towards the user equipment, the information comprising an indication of the activated or deactivated one or more transmission configuration indicator states.

In accordance with an example embodiment, the apparatus may comprise a network node of a candidate cell of a communication network.

In accordance with an example embodiment, the information may comprise an activation information.

In accordance with an example embodiment, based on the information, the network node may be configured to transmit at least one of a synchronization signal block, a channel state information-reference signal, a tracking reference signal, or other signal.

In accordance with an example embodiment, there may be receiving from the source network information comprising a configuration of a timer.

In accordance with an example embodiment, there may be based on the information, starting the timer during a communication with the source network.

In accordance with an example embodiment, the network node may be configured to maintain the timer.

In accordance with an example embodiment, the network node may be configured to start the timer during the communication with the source network.

In accordance with an example embodiment, when the timer is running, the network node may be configured to identify the activated or deactivated one or more transmission configuration indicator states as active, and wherein the activated or deactivated one or more transmission configuration indicator states are indicated for the user equipment.

In accordance with an example embodiment, the network node may be configured to transmit at least one of a synchronization signal block, a channel state information-reference signal, a tracking reference signal, or other signal while the timer is running.

In accordance with an example embodiment, the network node may be configured to provide communication to the user equipment on one or more resources associated with the activated or deactivated one or more transmission configuration indicator states while the timer is running.

In accordance with an example embodiment, the network node may be configured to provide communication to the user equipment based on a beam indication provided to the user equipment is indicating one of the activated or deactivated one or more transmission configuration indicator states.

In accordance with an example embodiment, the network node may be configured to, based on expiration of the timer, de-activate the activated one or more transmission configuration indicator states communicated by the source cell after a time duration T.

In accordance with an example embodiment, the network node may be configured with the time duration T in the communication.

In accordance with an example embodiment, the configuration of the timer may be communicated as part of a lower layer mobility configuration.

In accordance with an example embodiment, the configuration of the timer may be communicated as part of the lower layer mobility configuration comprises at least one of a layer 1 or layer 2 triggered mobility configuration.

In accordance with an example embodiment, the configuration of the timer may be specific for a candidate cell or set of candidate cells of the at least one candidate cell.

In accordance with an example embodiment, there may be receiving from the source network an indication to release at least one activation for a beam indication, wherein the release enables the at least one candidate cell to determine not to transmit one or more reference signals associated with the activated or deactivated one or more transmission configuration indicator states activated for the lower layer mobility configuration for a user equipment.

In accordance with an example embodiment, the indication to release the at least one activation sent to a candidate target cell may comprise one or more of the activated transmission configuration indicator states selected from activated transmission configuration indicator states of a candidate cell.

In accordance with an example embodiment, there may be based on a cell switch command sent to the user equipment, determining an indication to not release at least one activation for a beam indication.

In accordance with an example embodiment, the indication to release may cause the timer to restart for managing and maintaining the active state of the one or more of the activated transmission configuration indicator states.

In accordance with an example embodiment, the indication to release may comprise one or more activated transmission configuration indicator states selected from activated transmission configuration indicator states of the candidate cell.

In accordance with an example embodiment, there may be determining information on a beam indication or an activated transmission configuration indicator state to a specific target cell.

In accordance with an example embodiment, there may be provided an apparatus comprising: means for receiving, by a network node of a communication network with a source network, during or after a cell change with a user equipment a message of one of activated or deactivated one or more transmission configuration indicator states; and means for sending towards the user equipment, information comprising an indication of the one of activated or deactivated one or more transmission configuration indicator states.

FIG. 4C illustrates operations which may be performed by a network device. As shown in step 470 of FIG. 4C there is receiving information comprising an indication of activated or deactivated one or more transmission configuration indicator states. As shown in step 480 of FIG. 4C there is, based on the information, determining a timer configuration for validating the activated or deactivated one or more transmission configuration indicator states.

In accordance with an example embodiment, the apparatus may be embodied in a user equipment of a communication network.

In accordance with an example embodiment, the timer configuration may be used for validating the one of activated or deactivated one or more transmission configuration indicator states

In accordance with an example embodiment, the timer configuration may configure a timer that is started when the indication of the activated or deactivated one or more transmission configuration indicator states is for lower layer purposes.

In accordance with an example embodiment, the timer configuration communicated as part of the lower layer may comprise at least one of a layer 1 or layer 2 triggered mobility configuration.

In accordance with an example embodiment, when the timer is running, the user equipment may identify the activated or deactivated one or more transmission configuration indicator states as active, and prepares for one of a cell switch or beam indication switch to the activated one or more transmission configuration indicator states.

In accordance with an example embodiment, based on the information, the user equipment may be configured to provide communication on one or more resources associated with the activated or deactivated one or more transmission configuration indicator states while the timer is running.

In accordance with an example embodiment, based on the information, the user equipment may be configured to receive or transmit communication based on a beam indication is of the one of activated or deactivated one or more transmission configuration indicator states.

In accordance with an example embodiment, based on the information, the user equipment may be configured to monitor at least one of a synchronization signal block, a channel state information-reference signal, or a tracking reference signal associated with the activated or deactivated one or more transport configuration transmission configuration indicator states.

In accordance with an example embodiment, based on expiration of the timer, the user equipment may assume transmission configuration indicators associated with the timer are to be de-activated.

### Benefits

Knowledge of activated TCI states at the respective candidate target cell is beneficial, e.g., in terms of scheduling of relevant DL RSs. For example, a candidate target cell may turn off a RS transmission if there is no activated TCI states associated with that RS (for example, the candidate cell may apply energy saving mechanism to avoid transmission of CSI-RS/CSI-RS for TRS if there are no UEs that would need to be served by the beam associated with the TCI State).

Implicit management of the activated TCI states is handled via timer: based on a timer maintained at the candidate cell.

The benefit and/or motivation is that the beam indication for LTM cell switch may never be provided to that specific candidate cell, thus the cell would maintain activated status for the TCI states for prolonged period (i.e., it would need assume that UE may be handed over to that target cell, even be prepared to provide UL grant/send TRS/CSI-RS).

Additionally, it provides for candidate cell way to maintain readiness for a set of TCI states (instead of all the potential TCI states) as activated that could be “potential candidates” before the actual activation by the serving cell.

It provides a candidate cell a mechanism to limit the TCI States that can be activated for the UE. This provides a way to perform load balancing/load management (e.g. in the spatial domain) for the candidate DUs resources.

Similarly, it would be beneficial for a candidate cell to be aware of any deactivation of the activated TCI states.

Further, in accordance with example embodiments of the present disclosure there is circuitry for performing operations in accordance with example embodiments of the present disclosure as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the present disclosure as described herein.

In accordance with one example embodiment, a timer that supervises the active TCI states may be started when the UE successfully connects to the new target cell. Thus, the timer may not need to be started when the activation command is received; prior to the UE connecting to the new target cell. In another example the timer may be started when the activation command activating or more TCI States is received, and the timer may be further re-started when the UE connects to the new target cell (as a result of LTM cell switch or LTM based handover). The TCI state activation may not need to start the timer prior to the cell switch, such as in the case the HO completion to an LTM target initiates the timer. This is different from TCI state activation which would start the timer prior to the cell switch; in the case the HO completion to an LTM target initiates the timer.

In a typical scenario, the UE may be provided an activation command for a set of TCI States (one or more) that can be indicated by the network. Furthermore, in a LTM scenario, the UE may have one or more candidate cells. In LTM context the indication of at least one TCI State may instruct the UE to connect to the target cell using the indicated TCI State. TCI state provides the UE the information of a reference signal (e.g., DL RS) that is used for reference for downlink reception of uplink transmission.

One motivation for the LTM (e.g. compared to the conventional L3 mobility) is the support for (subsequent) LTM based switch and/or the switch that can be made using the lower layer signaling wherein the lower layer signaling indicates the UE a beam switch type of operation for HO instead of performing RACH based HO (which might otherwise cause interrupt or lower throughput of data/connectivity between UE and network). LTM based switch may also use RACH based handover, but the TCI state(s) may be activated and/or indicated prior to the cell switch or indicated in the LTM cell switch command. Although RACH based LTM switch may cause interruption, if the previously activated TCI states are maintained, the UE can be switched to another target cell or to another TCI state in the target cell (for beam management) with less delay. As an example, the UE may be switched between a set of cells (including a switch back a previous serving cell in case the serving cell is configured as LTM candidate cell), using beam indication. Using the beam indication for switching, a minimal interruption to data communication may be assumed. Beam indication may indicate at least one previously activated TCI state. Beam indication may, in some cases, indicate at least one TCI state (that is not previously activated) causing the indicated TCI state to be activated (and indicated). In some examples, activating one TCI state may cause the activated TCI state to be indicated.

Since the lower layer signaling utilizes beam indication (or indication of a TCI State or indication of an activated TCI State) to indicate the UE the current QCL assumption to be used in the target cell it is imperative that the TCI states, that can be indicated in the cell switch command, are managed efficiently. The QCL assumption may refer to the UE assumption or reference for receiving downlink channels (PDCCH and/or PDSCH) or transmission on uplink channels (PUCCH and/or PUSCH).

The TCI States that can be indicated are typically referred as active TCI States. In some examples, a TCI State that is not activated, can be indicated (and indication further causing the activation of the TCI State)

Active TCI state means that UE is assumed to perform beam switch to the active TCI State with specified time (sometimes referred as beam application time i.e. the time in which the beam or the new TCI state is to be applied/used).
If the TCI states are deactivated right after the switch, it would prevent efficient (subsequent) LTM cell switch.
Alternatively, if the new target cell would always need to deactivate TCI states for specific cell or cells it increases signalling overhead and increases resource utilization.
It may also reduce the network scheduling flexibility due to additional signaling required; i.e., signaling the deactivation.

Keeping some or all TCI states active after the LTM cell switch is beneficial in the (subsequent) LTM case, but in case a (subsequent) LTM cell switch will not happen within a reasonable time frame after the first LTM cell switch, it is not defined how long the TCI states should be kept active after the first cell switch. TCI being active means that the UE is performing (fine) time/frequency tracking of the TCI state (of the DL RS included in the TCI state), which may consume UE resources unnecessarily if TCI states are kept active for a long time when not needed. In some examples, the LTM switch may be referred to as a subsequent LTM cell switch, wherein the UE is switched to another target cell (for which the UE has LTM candidate cell configuration) after performing an LTM cell switch to a target cell. In some examples, the subsequent LTM switch may refer to the cell switch (back) to the previous serving cell.

In one example embodiment, a timer T may be configured for the supervision of active TCI states (for LTM) after the UE enters (successfully connects) to the new target LTM cell. The timer T may be associated with one or more TCI States. The timer may be started when the UE successfully connects to the target cell using the indicated TCI in the cell switch command. For example, when the UE transmits RRC reconfiguration complete or the UE receives acknowledgement for the UL-SCH transmission carrying the RRC reconfiguration complete, the timer may be started. The timer may be re-started when the UE successfully connects to the target cell using the indicated TCI in the cell switch command and the timer is running, for example when the timer has been started upon receiving the TCI state activation command prior to cell switch.

While timer is running the UE may be considering the TCI states, associated with the timer T, that were activated before the cell switch to be active (after the cell switch).

When the timer T expires, the UE may assume the TCI states associated with the timer are not active anymore.

In one example, the timer described with reference to FIG. 3 above may be re-started upon cell switch. In other words, the method described in U.S. provisional patent application No. 63/459,035 and described above may be used to start a timer (when the activation command is received), and that timer may be re-started (in some examples referred as timer T) with features as described herein when the UE has been determined to have successfully connected to the new target cell.

In one example, the timer T may supervise all TCI States for one or more cells that the UE has received activation command prior to the cell switch.

In one example, the timer T may be configured for TCI States per candidate LTM cell.

In one example, the timer T may be configured for TCI States per candidate LTM cell wherein a candidate LTM cell is a secondary (serving) cell of the UE (SCell).

In one example, the timer T may be configured for per TCI State or set of TCI states per candidate LTM cell. Whether the timer T applies, may be configured using RRC signaling.

In one example, the timer T may be configured using RRC signaling. The timer T configuration may be commonly configured for all the LTM candidate cells, or the timer T may be configured in the LTM candidate cell configuration.

In one example, the timer T may be configured for specific target BWP of the target cell.

In one example, upon receiving a new TCI state activation for at least one LTM cell, all the configured timer(s) T may expire.

In one example, the timer T may have values expressed in seconds or milliseconds or other time units. The timer T value may be expressed in reference signal periodicity values such as, for example, 1,2,3 downlink reference signal periods. Example downlink reference signal periodicity may be 20 ms, 40 ms and so on. Examples of durations may be 128 ms, 256 ms, 512 ms, 1024 ms and so on. Please note that these are merely examples. The timer value may be configured by network. Timer T value may be indicated using MAC/PHY signaling such as, for example, MAC CE or DCI.

In one example, upon receiving a new TCI state activation or indication of a TCI state for intra or inter-cell beam management in the new serving cell, all the configured timer(s) T may expire.

In one example, upon receiving a new cell switch command after previous cell switch without receiving new TCI state activation for LTM, the timer may expire when connecting to the new cell. In one example, upon receiving a new cell switch command after previous cell switch without receiving new TCI state activation for LTM, the timer may be restarted when connecting to the new cell. In one example, the timer may be started for the activated TCI States when the UE connects to the new target cell.

In one example, upon receiving a new indicated TCI state in the target cell, the timer may be configured to expire.

In one example, the MAC CE providing the TCI activation for LTM may comprise an indication whether a timer is started after cell switch.

In one example, the timer T may be configured in the MAC layer. In one example the timer T may be configured at RRC layer.

The timer may be started for TCI states associated with the cell for which the UE has previously performed at least on PRACH transmission for TA acquisition or has acquired a TA value.

In one example, the UE may be configured to indicate to the new serving cell the target cells and/or one or more active TCI States associated with the target cells.

In one example, the UE may be configured to start the timer for maintaining/retaining the activated TCI States of only the previous serving cell.

In one example, the target cell may indicate explicitly, for example in a downlink MAC CE/DCI, that timer T is to be expired. In another example, the reception of the message may cause the timer T to expire.

In one example, if the UE utilizes (falls back) RACH-based LTM procedure (e.g., due to being unable to use the indicated TCI state in the cell switch command or/and due to timing advance acquisition), the timer T may not be (re-)started.

In one example, if the UE utilizes (falls back) RACH-based LTM procedure (e.g., due to being unable to use the indicated TCI state in the cell switch command or/and due to timing advance acquisition), the timer T may expire if the timer is running.

In one example, if the UE determines that it is not required to measure L1-RSRP for LTM for a specific cell or beam (DL RS e.g. SSB/CSI-RS), the timer T associated with that cell or TCI state including the beam (DL-RS) may expire. In some examples, if the UE determines is not required to measure or report L1-RSRP for LTM (or other measurements for LTM) the timer T expires upon determining.

In one example the timer (timer T) may be started for TCI states for intra-cell (serving cell beam management). In one example the timer (timer T) may be started for TCI states for inter-cell beam management. The common timer T may be used for supervising the active status of LTM TCI states and intra/inter cell TCI states. In another example the timer may be specific for intra/inter cell BM (e.g. Timer T_intra/inter). In an example the timer may be specific for LTM TCI state supervision (e.g. Timer T_LTM). Thus, the timer may be common for LTM and intra/inter cell BM or the timers may be separate. Similar configuration options apply for the Timer T_intra/inter e.g. it may be specific for a cell or set of cells. It may be specific for TCI state or set of TCI states. The TCI states for serving cell beam management (in the target cell/new serving cell) may be activated prior to the cell switch. Upon connecting to the cell, the timer is started (or if the timer is running, it is restarted). While the timer running, considering the one or more transmission configuration indicator states as being active for intra and/or inter cell beam management within the target cell. When the timer has expired, the UE determines that the TCI states associated with the timer are deactivated. In inter-cell beam management, the UE may be configured to communicate with a cell that is not a serving cell (i.e. has a PCI different than a serving cell) while being connected to the serving cell.

In a conventional LTM scenario, when a beam switch (beam switch based LTM cell switch) is executed to an active TCI state, the following questions arise:
If the TCI states are deactivated right after the switch, it would prevent efficient (subsequent) LTM cell switch.
If the new target cell would always need to deactivate TCI states for specific cell or cells, it increases signalling overhead and increases resource utilization. This may also reduce the network scheduling flexibility.
Keeping some or all TCI states active after the LTM cell switch is beneficial in the subsequent LTM case.
However, in case subsequent LTM cell switch will not happen within a reasonable time frame after the first LTM cell switch, it is unclear how long the TCI states should be kept active. TCI being active means that the UE is tracking the timing of the TCI state, which may consume UE resources unnecessarily, if TCI states are kept active for a long time when not needed.

Features as described herein may be used to enable keeping some or all TCI states active, after an LTM cell switch, to thereby enable the UE to be commanded quickly to a new LTM cell (if needed).

Features as described herein may be used for enabling the UE to be commanded back to the previous serving cell.

Features as described herein may be used for introducing a timer which, without an explicit message from the network, enables a UE to stop monitoring old activated TCI states; saving some network-UE signaling overhead. This will also save UE power and resources, because the UE would then not be expected to continue keeping track of the timing of these TCI states indefinitely.

Features as described herein may be used to supervise the active TCI states for LTM after the UE enters the new target LTM cell by a timer. The timer may be started when the UE successfully connects to the target cell using the indicated TCI state in the cell switch command. While the timer is running, the TCI states activated before the cell switch may be kept active. When the timer T expires, the TCI states may be deactivated.

Some further options may include:
The timer may supervise all TCI States for one or more cells that the UE has received activation command prior to the cell switch.
The timer may be configured for TCI States per candidate LTM cell.
The timer may be configured per TCI State or set of TCI states per candidate LTM cell.
The timer may be configured for specific target BWP of the target cell.
Upon receiving a new TCI state activation for at least one LTM cell, all configured timers may expire.
The timer may be starter for TCI states associated with the cell for which the UE has previously performed at least on PRACH transmission for TA acquisition or has acquired a TA value.
If the UE utilizes (falls back) RACH-based LTM procedure, the timer T may not be started.

With features as described in U.S. provisional patent application No. 63/459,035, the TCI state activation may start the timer prior to the cell switch. With features as described herein, a timer which supervises the active TCI States may be started when the UE successfully connects to the (new) target, i.e., HO/cell switch completion to an LTM target starts the timer.

U.S. provisional patent application No. 63/459,035 provides for a common awareness, both at the serving cell and the candidate target cells, on the candidate activated TCI state and the actually activated TCI states, and to ensure that the UE considers only active TCI states to be prepared for LTM cell switch. With features as described herein, a TCI state may be kept active after a LTM cell switch, to be prepared for an LTM cell switch. However, this may be to limit the tracking time of TCI state; not to consume UE resources unnecessarily. Features as described herein may be used to ensure an efficient LTM cell switch avoiding an increase of signalling overhead and resource utilization, but keeping network scheduling flexibility.

For a UE, the timer T may be configured for the supervision of active TCI states (for LTM) after the UE enters the new target LTM cell. With transmitting RRC reconfiguration complete or receiving acknowledgement for the UL-SCH transmission carrying the RRC reconfiguration complete after cell switch (LTM), the UE may start the timer. As long as the timer is running, the UE may consider the TCI states associated with the timer that were activated before the LTM cell switch for an LTM cell switch. When the timer expires, the UE does not need to consider the TCI states anymore for an LTM cell switch.

For the target cell, the timer T (timer T_network) may be started at the target cell when the UE enters/connects successfully to the new target cell. While the timer T_network is running the target cell may assume that UE has active TCI states for indication. Indication may be when the timer T_network expires, the target cell may determine that TCI States are not active anymore.

The timer T (timer T_network) may also be started on source cell. The timer may be started when a cell switch command is provided or when the UE acknowledges it; enabling fast switch back to the previous serving cell. When the timer is running, the cell may assume that UE has active TCI states (or maintains the active TCI states that were previously activated).

In one example, the list of activated TCI states may be transmitted by the source cell to the target cell, and then target cell starts the timer T (T_network) when the UE connects to the cell.

Features as described herein may be used with a network side timer. The network (target cell) should know what are the active TCI states at the UE (where the timer T at the UE has not expired), so that the network (target cell) can indicate one of such activated TCI state for cell switch without activating it again. A method may be provided with a UE indication signaling the active TCI states to the target cell, where the UE may indicate to a new serving cell information regarding the LTM candidate cells and/or one or more active transmission configuration indicator states associated with the LTM candidate cells. Another example may be provided where the list of active TCI states (and associated candidate cells) for the UE may be transmitted from the source cell to the target cell, and then the target cell can start the network side timer.

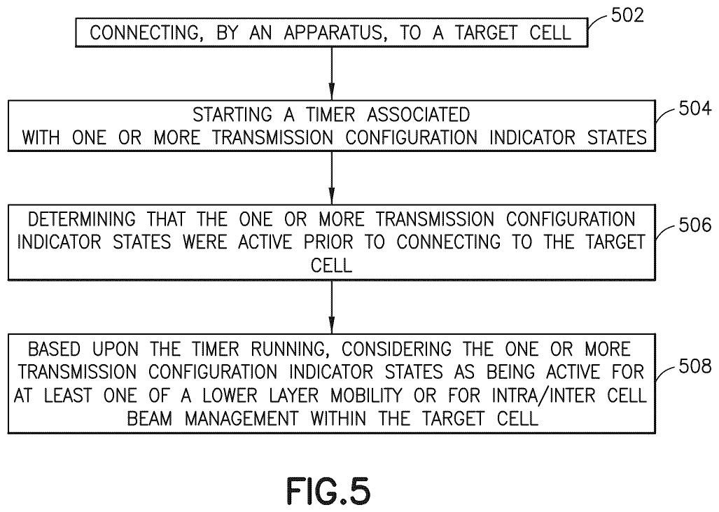

Referring also to FIG. 5, in accordance with an example embodiment, a method is provided comprising: connecting, with an apparatus, to a target cell as indicated with block 502; starting a timer associated with one or more transmission configuration indicator states as indicated with block 504; determining that the one or more transmission configuration indicator states were active prior to connecting to the target cell as indicated with block 506; and based upon the timer running, considering the one or more transmission configuration indicator states as being active for at least one of a lower layer mobility or for intra/inter cell beam management within the target cell as indicated with block 508.

The method may further comprise, when the timer expires, considering the one or more transmission configuration indicator states, associated with the timer, as not being active for lower layer mobility. The apparatus may comprise a user equipment. The determining that that apparatus has connected to a target cell may comprise determining when the apparatus successfully connects to the target cell using an indicated transmission configuration indicator in a cell switch command. The determining that that apparatus has connected to a target cell may comprise determining when the apparatus transmits a RRC reconfiguration complete or the apparatus receives an acknowledgement for an uplink shared channel (UL-SCH) transmission carrying the RRC reconfiguration complete. The determining that that apparatus has connected to a target cell may comprise determining when the apparatus connects to a target cell using random access procedure. The starting of the timer may comprise re-starting the timer, where the timer comprises a timer which was previously started based upon an activation command having been received. The timer may supervise one or more transmission configuration indicator states for one or more LTM candidate cells for which the apparatus has received an activation command prior to a cell switch to the target cell. The timer may be configured for transmission configuration indicator states per LTM candidate cell or set of candidate cells. The timer may be configured per transmission configuration indicator state or for a set of transmission configuration indicator states per LTM candidate cell. Use of the timer may be determined based upon RRC signaling. The timer may be configured for a specific target BWP of a LTM candidate cell. The method may further comprise, based upon receiving a new transmission configuration indicator state activation for at least one LTM candidate cell, causing one or more configured timer(s) to expire. The method may further comprise, based upon receiving a new TCI state activation for intra-cell or inter-cell beam management in a target cell, target cell being new serving cell, causing one or more configured timer(s) to expire. The method may further comprise, based upon receiving a new cell switch command after a previous cell switch without receiving a new TCI state activation for LTM, causing one or more timers to expire after connecting to the new cell. The method may further comprise, based upon receiving a new indicated transmission configuration indicator state in the target cell, causing the timer to expire. The method may further comprise receiving a MAC CE providing a transmission configuration indicator activation for LTM comprising an indication whether the timer is started after a cell switch. The method may further comprise the timer being started for transmission configuration indicator states associated with a cell for which the apparatus has previously performed at least one PRACH transmission for TA acquisition or has acquired a TA value. The method may further comprise the apparatus indicating to a new serving cell about the LTM candidate cells and/or one or more active transmission configuration indicator states associated with the LTM candidate cells. The method may further comprise starting the timer for maintaining or retaining activated transmission configuration indicator states of only a previous serving cell. The method may further comprise receiving from the target cell an explicit indication that timer is to be expired. The explicit indication may be received in a downlink MAC CE/DCI message. Reception of the message may cause the timer to expire. The method may further comprise, when the timer is running, expiring the timer when the apparatus utilizes a RACH-based LTM procedure. The method may further comprise causing the timer, associated with a specific cell or beam, to expire when the apparatus determines that it is not required to measure L1-RSRP for LTM for that specific cell or beam.

In accordance with an example embodiment, a method may be provided comprising: determining that an apparatus has connected to a target cell; starting a timer associated with one or more transmission configuration indicator states; determining that the one or more transmission configuration indicator states were active prior to connecting to the target cell; and based upon the timer running, considering the one or more transmission configuration indicator states as being active for a lower layer mobility.

In accordance with an example embodiment, a method may be provided comprising: determining that an apparatus has connected to a target cell; starting a timer associated with one or more transmission configuration indicator states; determining that the one or more transmission configuration indicator states were active prior to connecting to the target cell; and based upon the timer running, considering the one or more transmission configuration indicator states as being active for intra/inter cell beam management within the target cell.

In accordance with an example embodiment, an apparatus may be provided comprising: at least one processor; and at least one non-transitory memory storing instructions that, when executed with the at least one processor, cause the apparatus to perform: connecting, with the apparatus, to a target cell; starting a timer associated with one or more transmission configuration indicator states; determining that the one or more transmission configuration indicator states were active prior to connecting to the target cell; and based upon the timer running, considering the one or more transmission configuration indicator states as being active for at least one of a lower layer mobility or for intra/inter cell beam management within the target cell.

The instructions, when executed with the at least one processor, may cause the apparatus to perform, when the timer expires, considering the one or more transmission configuration indicator states, associated with the timer, as not being active for lower layer mobility. The apparatus may comprise a user equipment. The apparatus may be configured such that the determining that that apparatus has connected to a target cell comprises determining when the apparatus successfully connects to the target cell using an indicated transmission configuration indicator in a cell switch command. The apparatus may be configured such that the determining that that apparatus has connected to a target cell comprises determining when the apparatus transmits a RRC reconfiguration complete or the apparatus receives an acknowledgement for an uplink shared channel (UL-SCH) transmission carrying the RRC reconfiguration complete. The apparatus may be configured such that the determining that that apparatus has connected to a target cell comprises determining when the apparatus connects to a target cell using random access procedure. The apparatus may be configured such that the starting of the timer comprises re-starting the timer, where the timer comprises a timer which was previously started based upon an activation command having been received. The apparatus may be configured such that the timer supervises one or more transmission configuration indicator states for one or more LTM candidate cells for which the apparatus has received an activation command prior to a cell switch to the target cell. The apparatus may be configured such that the timer is configured for transmission configuration indicator states per LTM candidate cell or set of candidate cells. The apparatus may be configured such that the timer is configured per transmission configuration indicator state or for a set of transmission configuration indicator states per LTM candidate cell. The apparatus may be configured such that use of the timer is further determined based upon RRC signaling. The apparatus may be configured such that the timer is configured for a specific target BWP of a LTM candidate cell. The instructions, when executed with the at least one processor, may cause the apparatus to perform, based upon receiving a new transmission configuration indicator state activation for at least one LTM candidate cell, causing one or more configured timer(s) to expire. The instructions, when executed with the at least one processor, may cause the apparatus to perform, based upon receiving a new TCI state activation for intra-cell or inter-cell beam management in a target cell, where the target cell is a new serving cell, causing one or more configured timer(s) to expire. The instructions, when executed with the at least one processor, may cause the apparatus to perform, based upon receiving a new cell switch command after a previous cell switch without receiving a new TCI state activation for LTM, causing one or more timers to expire after connecting to the new cell. The instructions, when executed with the at least one processor, may cause the apparatus to perform, based upon receiving a new indicated transmission configuration indicator state in the target cell, causing the timer to expire. The instructions, when executed with the at least one processor, may cause the apparatus to perform receiving a MAC CE providing a transmission configuration indicator activation for LTM comprising an indication whether the timer is started after a cell switch. The instructions, when executed with the at least one processor, may cause the apparatus to perform the timer being started for transmission configuration indicator states associated with a cell for which the apparatus has previously performed at least one PRACH transmission for TA acquisition or has acquired a TA value. The instructions, when executed with the at least one processor, may cause the apparatus to perform indicating to a new serving cell about the LTM candidate cells and/or one or more active transmission configuration indicator states associated with the LTM candidate cells. The instructions, when executed with the at least one processor, may cause the apparatus to perform starting the timer for maintaining or retaining activated transmission configuration indicator states of only a previous serving cell. The instructions, when executed with the at least one processor, may cause the apparatus to perform receiving from the target cell an explicit indication that timer is to be expired. The explicit indication may be received in a downlink MAC CE/DCI message. Reception of the message may causes the timer to expire. The instructions, when executed with the at least one processor, may cause the apparatus to perform, when the timer is running, expiring the timer when the apparatus utilizes a RACH-based LTM procedure. The instructions, when executed with the at least one processor, may cause the apparatus to perform causing the timer, associated with a specific cell or beam, to expire when the apparatus determines that it is not required to measure L1-RSRP for LTM for that specific cell or beam.

In accordance with an example embodiment, an apparatus may be provided comprising: means for connecting, with the apparatus, to a target cell; means for starting a timer associated with one or more transmission configuration indicator states; means for determining that the one or more transmission configuration indicator states were active prior to connecting to the target cell; and means for, based upon the timer running, considering the one or more transmission configuration indicator states as being active for at least one of a lower layer mobility or for intra/inter cell beam management within the target cell.

In accordance with an example embodiment, a non-transitory program storage device readable by an apparatus may be provided, tangibly embodying a program of instructions executable with the apparatus for performing operations, the operations comprising: connecting, with the apparatus, to a target cell; starting a timer associated with one or more transmission configuration indicator states; determining that the one or more transmission configuration indicator states were active prior to connecting to the target cell; and based upon the timer running, considering the one or more transmission configuration indicator states as being active for at least one of a lower layer mobility or for intra/inter cell beam management within the target cell.

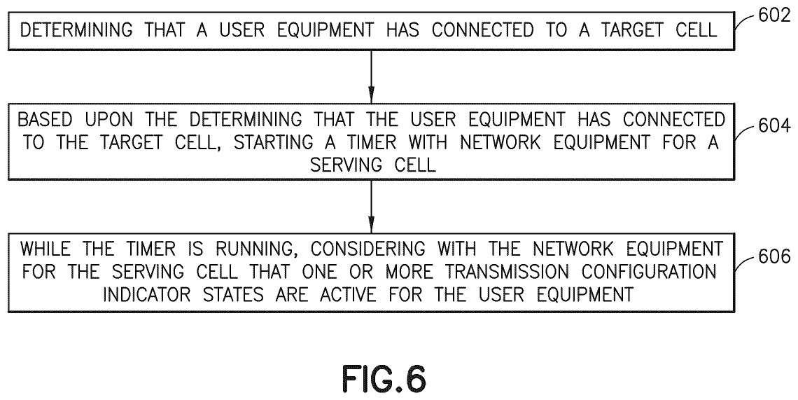

Referring also to FIG. 6, in accordance with an example embodiment, a method may be provided comprising: determining that a user equipment has connected to a target cell as indicated with block 602; based upon the determining that the user equipment has connected to the target cell, starting a timer with network equipment for a target cell (where the target cell may be a serving cell) as indicated with block 604; while the timer is running, considering with the network equipment for the target cell (where the target cell may be a serving cell) that one or more transmission configuration indicator states are active for the user equipment as indicated with block 606. The method may further comprise, based upon the timer expiring, considering with the network equipment for the target cell (where the target cell may be a serving cell) that the one or more transmission configuration indicator states are not active for the user equipment.

In accordance with an example embodiment, an apparatus may be provided comprising: at least one processor; and at least one non-transitory memory storing instructions that, when executed with the at least one processor, cause the apparatus to perform: determining that a user equipment has connected to a target cell; based upon the determining that the user equipment has connected to the target cell, starting a timer with network equipment of the apparatus for a serving cell; while the timer is running, considering with the network equipment for the serving cell that one or more transmission configuration indicator states are active for the user equipment. The instructions, when executed with the at least one processor, may cause the apparatus to perform, based upon the timer expiring, considering with the network equipment for the serving cell that the one or more transmission configuration indicator states are not active for the user equipment.

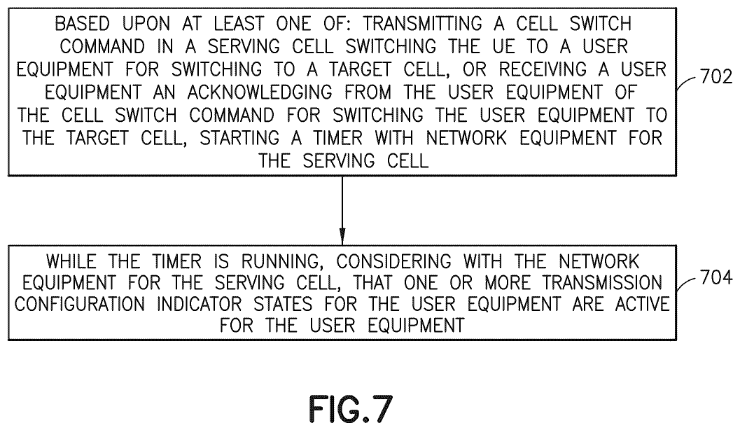

Referring also to FIG. 7, in accordance with an example embodiment, a method may be provided comprising: based upon at least one of: transmitting a cell switch command in a source cell to a user equipment for switching to a target cell, or receiving an acknowledging from the user equipment of the cell switch command for switching the user equipment to the target cell, starting a timer with network equipment for the source cell as indicated with block 702 (where the source cell may be a serving cell); and while the timer is running, considering with the network equipment for the source cell (where the source cell may be a serving cell), that one or more transmission configuration indicator states for the user equipment are active as indicated with block 704. The method may further comprise, based upon the timer expiring, considering with the network equipment for the source cell that the one or more transmission configuration indicator states are not active.

In accordance with an example embodiment, an apparatus may be provided comprising: at least one processor; and at least one non-transitory memory storing instructions that, when executed with the at least one processor, cause the apparatus to perform: based upon at least one of: transmitting a cell switch command in a serving cell to a user equipment for switching to a target cell, or receiving an acknowledging from the user equipment of the cell switch command for switching the user equipment to the target cell, starting a timer with network equipment of the apparatus for the serving cell; and while the timer is running, considering with the network equipment for the serving cell, that one or more transmission configuration indicator states for the user equipment are active. The instructions, when executed with the at least one processor, may cause the apparatus to perform, based upon the timer expiring, considering with the network equipment for the serving cell that the one or more transmission configuration indicator states are not active.

An example may be provided with a method comprising: determining that an apparatus has connected to a target cell; based upon the determining that the apparatus has connected to the target cell, starting a timer, where the timer is associated with one or more transmission configuration indicator states; after determining that the apparatus has connected to the target cell, determining whether the one or more the transmission configuration indicator states were active before the apparatus was connected to the target cell; and based upon the timer running and based upon the determining that the one or more the transmission configuration indicator states were active before the apparatus was connected to the target cell, considering the one or more transmission configuration indicator states as being active for a lower layer mobility or for intra/inter cell beam management within the target cell.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
at least one processor; and
at least one non-transitory memory storing instructions that, when executed with the at least one processor, cause the apparatus to perform:
connecting, with the apparatus, to a target cell;
starting a timer associated with one or more transmission configuration indicator states;
determining that the one or more transmission configuration indicator states were active prior to connecting to the target cell; and
based upon the timer running, considering the one or more transmission configuration indicator states as being active for at least one of a lower layer mobility or for intra/inter cell beam management within the target cell.

2. The apparatus as claimed in claim 1 where the instructions, when executed with the at least one processor, cause the apparatus to perform, when the timer expires, considering the one or more transmission configuration indicator states, associated with the timer, as not being active for lower layer mobility.

3. The apparatus as claimed in claim 1 where the apparatus comprises a user equipment.

4. The apparatus as claimed in claim 1 where the determining that that apparatus has connected to a target cell comprises determining when the apparatus successfully connects to the target cell using an indicated transmission configuration indicator in a cell switch command.

5. The apparatus as claimed in claim 4 where the determining that that apparatus has connected to a target cell comprises determining when the apparatus transmits a RRC reconfiguration complete or the apparatus receives an acknowledgement for an uplink shared channel (UL-SCH) transmission carrying the RRC reconfiguration complete.

6. The apparatus as claimed in claim 4 where the determining that that apparatus has connected to a target cell comprises determining when the apparatus connects to a target cell using random access procedure.

7. The apparatus as claimed in claim 1 where the starting of the timer comprises re-starting the timer, where the timer comprises a timer which was previously started based upon an activation command having been received.

8. The apparatus as claimed in claim 1 where the timer supervises one or more transmission configuration indicator states for one or more LTM candidate cells for which the apparatus has received an activation command prior to a cell switch to the target cell.

9. The apparatus as claimed in claim 1 where the timer is configured for transmission configuration indicator states per LTM candidate cell or set of candidate cells.

10. The apparatus as claimed in claim 1 where the timer is configured per transmission configuration indicator state or for a set of transmission configuration indicator states per LTM candidate cell.

11. The apparatus as claimed in claim 1 where use of the timer is further determined based upon RRC signaling.

12. The apparatus as claimed in claim 1 where the timer is configured for a specific target BWP of a LTM candidate cell.

13. The apparatus as claimed in claim 1 where the instructions, when executed with the at least one processor, cause the apparatus to perform, based upon receiving a new transmission configuration indicator state activation for at least one LTM candidate cell, causing one or more configured timer(s) to expire.

14. The apparatus as claimed in claim 1 where the instructions, when executed with the at least one processor, cause the apparatus to perform, based upon receiving a new TCI state activation for intra-cell or inter-cell beam management in a target cell, where the target cell is a new serving cell, causing one or more configured timer(s) to expire.

15. An apparatus comprising:
at least one processor; and
at least one non-transitory memory storing instructions that, when executed with the at least one processor, cause the apparatus to perform:
determining that a user equipment has connected to a target cell;
based upon the determining that the user equipment has connected to the target cell, starting a timer with network equipment of the apparatus for a target cell;
while the timer is running, considering with the network equipment for the target cell that one or more transmission configuration indicator states are active for the user equipment.

16. The apparatus as claimed in claim 15 where the instructions, when executed with the at least one processor, cause the apparatus to perform, based upon the timer expiring, considering with the network equipment for the target cell that the one or more transmission configuration indicator states are not active for the user equipment.

17. The apparatus as claimed in claim 15 where the target cell is a serving cell.

18. An apparatus comprising:
at least one processor; and
at least one non-transitory memory storing instructions that, when executed with the at least one processor, cause the apparatus to perform:
based upon at least one of: transmitting a cell switch command in a source cell to a user equipment for switching to a target cell, or receiving an acknowledging from the user equipment of the cell switch command for switching the user equipment to the target cell, starting a timer with network equipment of the apparatus for the source cell; and
while the timer is running, considering with the network equipment for the source cell, that one or more transmission configuration indicator states for the user equipment are active.

19. The apparatus as claimed in claim 18 where the instructions, when executed with the at least one processor, cause the apparatus to perform, based upon the timer expiring, considering with the network equipment for the source cell that the one or more transmission configuration indicator states are not active.

20. The apparatus as claimed in claim 18 where the source cell is a previous serving cell of the user equipment.
